(19) United States
(12) Patent Application Publication
(10) Pub. No.: US 2019/0238792 A1
(43) Pub. Date: Aug. 1, 2019

(54) CONVERSION DEVICE, CONNECTION CONFERENCE SYSTEM AND CONNECTION CONFERENCE METHOD

(71) Applicant: AVer Information Inc., New Taipei City (TW)

(72) Inventors: Ming-Kang CHUANG, New Taipei City (TW); Chi-Wei CHIANG, New Taipei City (TW)

(21) Appl. No.: 16/166,147

(22) Filed: Oct. 21, 2018

(30) Foreign Application Priority Data
Jan. 26, 2018 (TW) 107102985

(51) Int. Cl. H04N 7/14; H04N 7/15

(52) U.S. Cl. CPC H04N 7/147; H04N 7/142; H04N 7/15

(57) ABSTRACT

The present disclosure provides a conversion device, a connection conference system and a connection conference method. This method includes steps as follows. A computer device executes video telephony software. A conference host establishes audio and video communications with a user device through network. The conference connection host receives a first audio signal and a first video signal outputted from the user device. The first audio signal and the first video signal are converted into a first converted audio signal and a first converted video signal supported by the video telephony software, and then the first converted audio signal and the first converted video signal are transmitted to the computer device.

### RELATED APPLICATIONS

This application claims priority to Taiwan Patent Application No. 107102985, filed Jan. 26, 2018, the entirety of which is herein incorporated by reference.

### BACKGROUND

### Field of Invention

The present disclosure relates to the apparatuses and methods, and more particularly, connection conference systems and methods.

### Description of Related Art

Video products have been developed over 40 years. From the original telephone box, through the continuous development of technology and communication, hardware equipment and software technology of the video conferencing system have been greatly improved. Today, video conferencing can be connected synchronically at any time to provide the motion picture of the conference on the screen, many-to-many interactive calls, splitting the screen, video recording, file sharing and other necessary functions for meetings. In current video image quality, remote participants can see each other as if they are sitting at a conference table, so that people from all over the world can feel like they are in the same conference room.

The traditional connection conference system integrates the various communication protocols by directly using various stack libraries, such as: H.323, SIP, Lync, etc. That is, the firmware of the connection conference system can support the above communication protocols. With the rapid development of modern video telephony software, various well-known video telephony softwares (e.g., Skype, Zoom, BlueJeans, Line and Facetime) have their own communication protocols. Not all communication software developers provide SDKs for a vendor. And if the vendor wants to integrate each communication protocol into the firmware layer of the connection conference system, it will inevitably cause problems of excessive code and memory space.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one or more various aspects, the present disclosure is directed to connection conference systems and methods.

An embodiment of the present disclosure is related to a connection conference system including a conference connection host and a conversion device. The conference connection host is configured to establish a video-audio communication with at least one user device through a network. The conversion device is electrically connected to the conference connection host and a computer device. The computer device executes a video telephony software, the conference connection host is configured to transmit an audio signal and a first video signal outputted by the at least one user device to the conversion device, and the conversion device is configured to convert the first audio signal and the first video signal into a first converted audio signal and a first converted video signal supported by the video telephony software and then transmit the first converted audio signal and the first converted video signal to the computer device.

In one embodiment, the computer device outputs a second audio signal and a second video signal to the conversion device, and the conversion device converts the second audio signal and the second video signal into a second converted audio signal and a second converted video signal supported by the video-audio communication and then transmits the second converted audio signal and the converted second video signal to the conference connection host, so that the conference connection host transmits the second converted audio signal and the second converted video signal to the at least one user device.

In one embodiment, the conversion device includes a connection port, a hub, a processing unit and an interface adapter. The connection port is used for electrically connecting the computer device. The hub is electrically connected to the connection port. The processing unit is electrically connected to the hub. The interface adapter is electrically connected the conference connection host with a first interface and electrically connected the processing unit with a second interface, so that the processing unit converts the first audio signal and the first video signal into the first converted audio signal and the first converted video signal supported by the video telephony software and then transmits the first converted audio signal and the first converted video signal to the computer device through the hub, and the processing unit converts the second audio signal into the second converted audio signal supported by the video-audio communication and then transmits the second converted audio signal to the conference connection host through the interface adapter.

In one embodiment, the conversion device further includes a display simulation chip. The display simulation chip is electrically connected to the hub, where the display simulation chip simulates the second video signal received from the hub into a simulated display signal of the computer device and transmits the simulated display signal to the processing unit, so that the processing unit converts the simulated display signal into the second converted video signal supported by the video-audio communication and then transmits the second converted video signal to the conference connection host through the interface adapter.

In one embodiment, the processing unit includes a connecting device, a codec and a re-sampling circuit. The connecting device is used for electrically connecting the interface adapter with the second interface. The codec is electrically connected to the connecting device and is configured to re-encode the first video signal into the first converted video signal supported by the video telephony software. The re-sampling circuit is electrically connected to the connecting device and is configured to re-sample and convert the first audio signal into the first converted audio signal supported by the video telephony software and to re-sample and convert the second audio signal into the second converted audio signal supported by the video-audio communication.

In one embodiment, the codec converts the simulated display signal into the second converted video signal supported by the video-audio communication.

In one embodiment, the conversion device further includes a video conversion device. The video conversion device is electrically connected to the conference connection host and the computer device, and the video conversion device is configured to convert the second video signal into the second converted video signal supported by the video-audio communication and then transmit the second converted video signal the conference connection host.

Another embodiment of the present disclosure is related to a conversion device including a connection port, a hub, a processing unit and an interface adapter. The connection port is used for electrically connecting a computer device, and the computer device executing a video telephony software. The hub is electrically connected to the connection port. The processing unit is electrically connected to the hub. The interface adapter is electrically connected a conference connection host with a first interface and is electrically connected the processing unit with a second interface. The conference connection host is configured to establish a video-audio communication with at least one user device through a network. The conference connection host is configured to transmit an audio signal and a first video signal outputted by the at least one user device to the interface adapter, so that the processing unit converts the first audio signal and the first video signal into a first converted audio signal and a first converted video signal supported by the video telephony software and then transmits the first converted audio signal and the first converted video signal to the computer device through the hub.

In one embodiment, the computer device outputs a second audio signal to the connection port, and the processing unit converts the second audio signal into a second converted audio signal supported by the video-audio communication and then transmits the second converted audio signal to the conference connection host through the interface adapter, so that the conference connection host transmits the second converted audio signal to the at least one user device.

In one embodiment, the conversion device further includes a display simulation chip. The display simulation chip is electrically connected to the hub, where the computer device outputs a second video signal to the connection port, and the display simulation chip simulates the second video signal received from the hub into a simulated display signal of the computer device and transmits the simulated display signal to the processing unit, so that the processing unit converts the simulated display signal into a second converted video signal supported by the video-audio communication and then transmits the second converted video signal to the conference connection host through the interface adapter.

In one embodiment, the processing unit includes a connecting device, a codec and a re-sampling circuit. The connecting device is used for electrically connecting the interface adapter with the second interface. The codec is electrically connected to the connecting device and is configured to re-encode the first video signal into the first converted video signal supported by the video telephony software. The re-sampling circuit is electrically connected to the connecting device and is configured to re-sample and convert the first audio signal into the first converted audio signal supported by the video telephony software and to re-sample and convert the second audio signal into the second converted audio signal supported by the video-audio communication.

In one embodiment, the codec converts the simulated display signal into the second converted video signal supported by the video-audio communication.

In one embodiment, the conversion device further includes a video conversion device. The video conversion device is electrically connected to the conference connection host and the computer device, and the video conversion device is configured to convert the second video signal into the second converted video signal supported by the video-audio communication and then transmit the second converted video signal the conference connection host.

Yet another embodiment of the present disclosure is related to a method including steps of: using a computer device executing a video telephony software; using a conference connection host to establish a video-audio communication with at least one user device through a network; receiving an audio signal and a first video signal outputted by the at least one user device from the conference connection host; and converting the first audio signal and the first video signal into a first converted audio signal and a first converted video signal supported by the video telephony software and then transmit the first converted audio signal and the first converted video signal to the computer device.

In one embodiment, the step of converting the first audio signal and the first video signal into the first converted audio signal and the first converted video signal supported by the video telephony software includes: re-encoding the first video signal into the first converted video signal supported by the video telephony software; and re-sampling and converting the first audio signal into the first converted audio signal supported by the video telephony software.

In one embodiment, the connection conference method further includes: receiving a second audio signal and a second video signal outputted by the computer device; and converting the second audio signal and the second video signal into a second converted audio signal and a second converted video signal supported by the video-audio communication and then transmitting the second converted audio signal and the converted second video signal to the conference connection host, so that the conference connection host transmits the second converted audio signal and the second converted video signal to the at least one user device.

In one embodiment, the step of converting the second audio signal and the second video signal into the second converted audio signal and the second converted video signal supported by the video-audio communication includes: re-sampling and converting the second audio signal into the second converted audio signal supported by the video-audio communication.

In one embodiment, the step of converting the second audio signal and the second video signal into the second converted audio signal and the second converted video signal supported by the video-audio communication further includes: simulating the second video signal into a simulated display signal of the computer device; and converting the simulated display signal into the second converted video signal supported by the video-audio communication, and then transmitting the second converted video signal to the conference connection host.

In view of the above, with the conversion technology of the present disclosure, there is no need to integrate each communication protocol into the firmware layer of the conference connection host, thereby avoiding the problems of excessive code and memory space.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1 is a block diagram of a connection conference system according to one embodiment of the present disclosure;

FIG. 2 is a block diagram of a connection conference system according to another embodiment of the present disclosure;

FIG. 3 is a block diagram of a connection conference system according to yet another embodiment of the present disclosure; and

FIG. 4 is a flow chart of a connection conference method according to one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

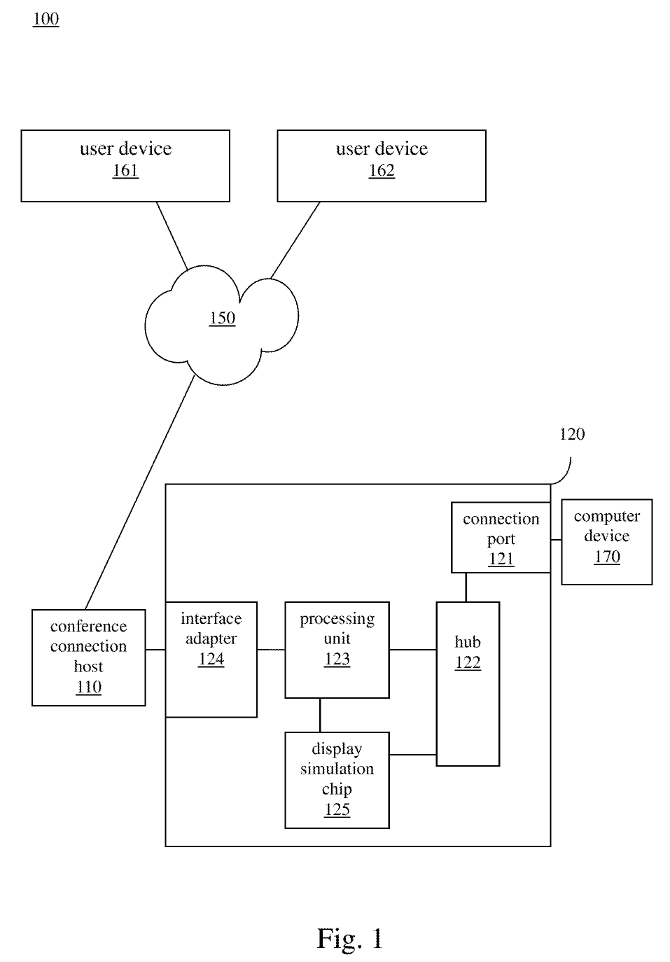

FIG. 1 is a block diagram of a connection conference system 100 according to one embodiment of the present disclosure. As shown in FIG. 1, a connection conference system 100 includes a conference connection host 110 and a conversion device 120. The conference connection host 110 is configured to establish a video-audio communication with user devices 161 and 162 (e.g., mobile devices, personal computers, etc.) through a network 150 (e.g., Internet). The conference connection host 110 supports the video-audio communication, so that the user devices 161 and 162 can creates video conference with the conference connection host 110.

A computer device 170 (e.g., a mobile device, a personal computer, etc.) executes video telephony software, but the conference connection host 110 cannot support the communication protocol of the video telephony software. When a user of the computer device 170 wants to join above-mentioned video conference, he or she needs the conversion device 120.

In structure, the conversion device 120 is electrically connected to the conference connection host 110 and the computer device 170. In use, the conference connection host 110 is configured to transmit audio signals and first video signals outputted by the user devices 161 and 162 to the conversion device 120, and the conversion device 120 is configured to convert the first audio signals and the first video signals into first converted audio signals and first converted video signals supported by the video telephony software and then transmit the first converted audio signal and the first converted video signal to the computer device. In this way, the user of the computer device 170 can watch and hear the video and sounds from the user devices 161 and 162.

The computer device 170 outputs a second audio signal and a second video signal to the conversion device 120, and the conversion device 120 converts the second audio signal and the second video signal into a second converted audio signal and a second converted video signal supported by the video-audio communication and then transmits the second converted audio signal and the converted second video signal to the conference connection host 110, so that the conference connection host 110 can transmit the second converted audio signal and the second converted video signal to the user devices 161 and 162. In this way, users of the user devices 161 and 162 can watch and hear the video and sounds from the computer device 170.

In FIG. 1, the conversion device 120 includes a connection port 121, a hub 122, a processing unit 123 and an interface adapter 124. For example, the connection port 121 may be a USB port, the hub 122 may be a USB hub, the processing unit 123 may be a system chip, and the interface adapter 124 may be a USB to Ethernet interface adapter.

In structure, the connection port 121 is used for electrically connecting the computer device 170. The hub 122 is electrically connected to the connection port 121. The processing unit 123 is electrically connected to the hub 122. The interface adapter 124 is electrically connected the conference connection host 110 with a first interface (e.g., a USB interface) and electrically connected the processing unit 123 with a second interface (e.g., a Ethernet interface). In use, the processing unit 123 converts the first audio signal and the first video signal into the first converted audio signal and the first converted video signal supported by the video telephony software and then transmits the first converted audio signal and the first converted video signal to the computer device 170 through the hub 122, and the processing unit 123 converts the second audio signal into the second converted audio signal supported by the video-audio communication and then transmits the second converted audio signal to the conference connection host 110 through the interface adapter 124.

As to the way of converting the second video signal, the conversion device 120 further includes a display simulation chip 125 (e.g., a DisplayLink chip). In structure, the display simulation chip 125 is electrically connected to the hub 122. In use, the display simulation chip 125 simulates the second video signal received from the hub 122 into a simulated display signal of the computer device 170 (i.e., the display of the video telephony software) and transmits the simulated display signal to the processing unit 123, so that the processing unit 123 converts the simulated display signal into the second converted video signal supported by the video-audio communication and then transmits the second converted video signal to the conference connection host 110 through the interface adapter 124.

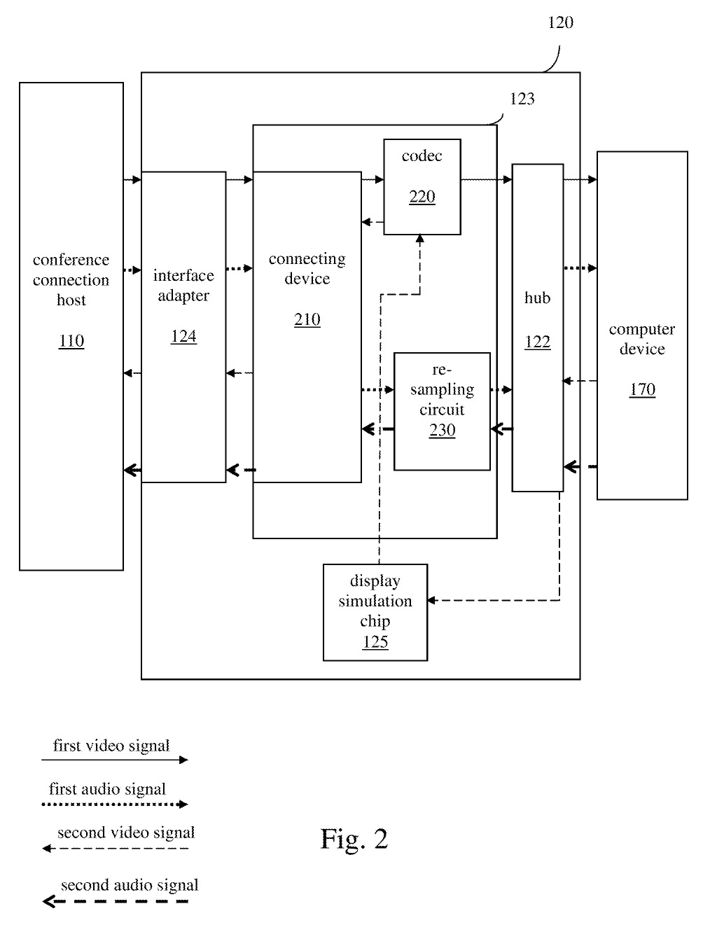

For a more complete understanding of the processing unit 123, refer to FIG. 2. The processing unit 123 includes a connecting device 210, a codec 220 and a re-sampling circuit 230. For example, the connecting device 210 may be an Ethernet interface connector.

In structure, the connecting device 210 is used for electrically connecting the interface adapter 124 with the second interface (e.g., the Ethernet interface). The codec 220 is electrically connected to the connecting device 230. The re-sampling circuit 230 is electrically connected to the connecting device 210. In use, the codec 220 is configured to re-encode the first video signal (e.g., H.264 video) into the first converted video signal (e.g., YUV or MJPEG video) supported by the video telephony software. The re-sampling circuit 230 is configured to re-sample and convert the first audio signal (e.g., 48 k audio) into the first converted audio signal (e.g., 32 k audio) supported by the video telephony software and to re-sample and convert the second audio signal (e.g., 32 k audio) into the second converted audio signal (e.g., 48 k audio) supported by the video-audio communication.

Moreover, the codec 220 converts the simulated display signal (e.g., YUV or MJPEG video) into the second converted video signal (e.g., H.264 video) supported by the video-audio communication.

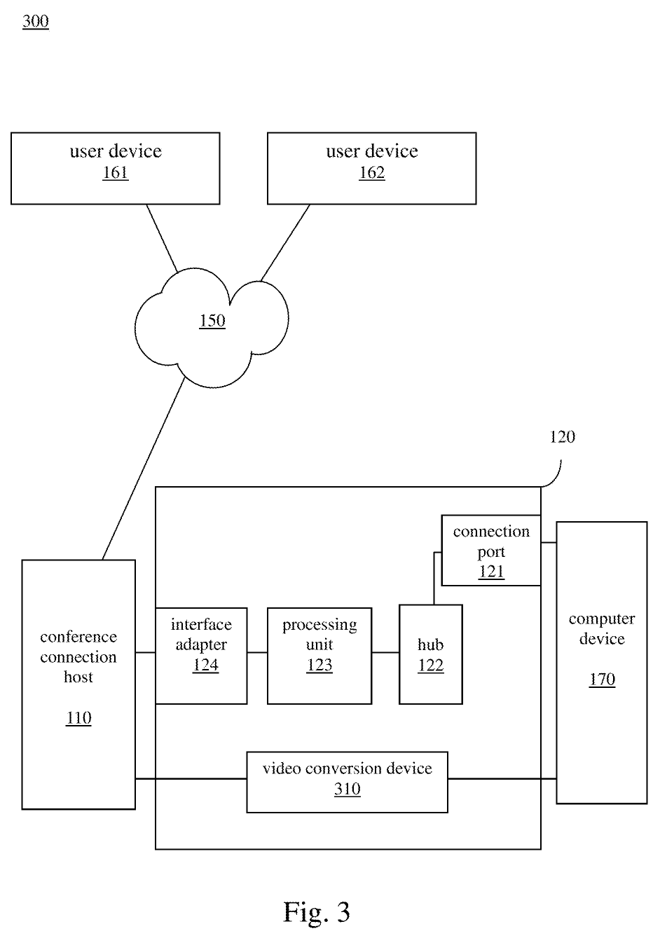

FIG. 3 is a block diagram of a connection conference system 300 according to another embodiment of the present disclosure. The connection conference system 300 is substantially the same as the connection conference system 100, except that a video conversion device 310 is replaced with the display simulation chip 125 in FIG. 1.

In FIG. 3, the conversion device 120 further includes a video conversion device 310. For example, the video conversion device 310 a digital signal processor (DSP). In structure, the video conversion device 310 is electrically connected to the conference connection host 110 and the computer device 170, and the conversion device 120 can convert signals (e.g., HDMI, VGA, DVI, Display port, eDP, and thunderbolt) of the computer device 170 into the interface format (e.g., HDMI, and VGA) supported by the conference connection host 110. For example, the computer device 170 outputs the second video signal to the conversion device 120, and the video conversion device 310 is configured to convert the second video signal into the second converted video signal supported by the video-audio communication and then transmit the second converted video signal the conference connection host 110.

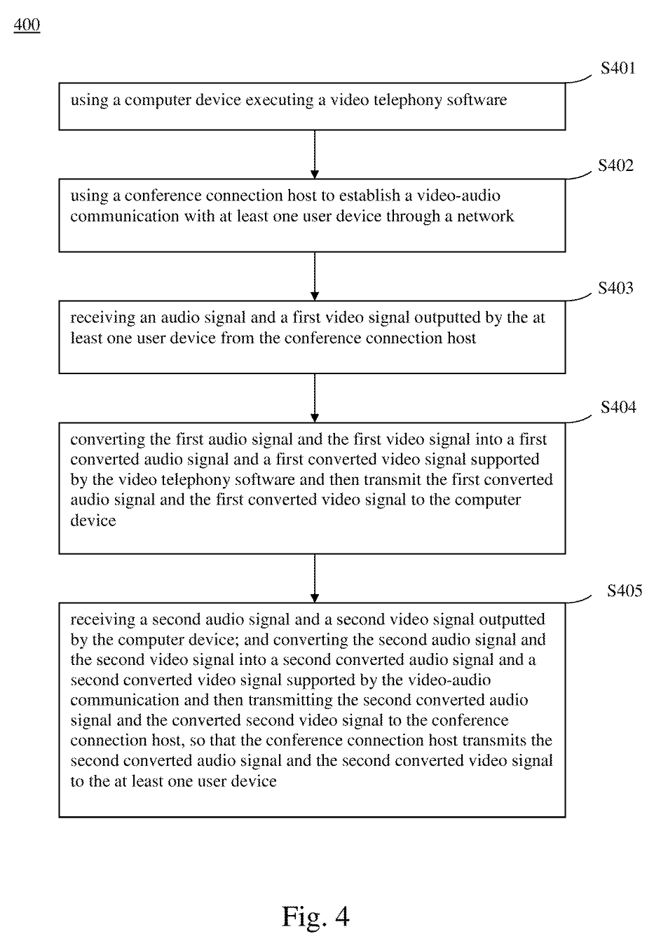

For a more complete understanding of a connection conference method performed by the connection conference systems, referring FIGS. 1 to 4, FIG. 4 is a flow chart of a connection conference method 400 according to one embodiment of the present disclosure. As shown in FIG. 4, the connection conference method 400 includes operations S401-S405. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

In operation S401, a computer device is used to execute video telephony software. In operation S402, a conference connection host is used to establish a video-audio communication with at least one user device through a network. In operation S403, an audio signal and a first video signal outputted by the at least one user device is received from the conference connection host. In operation S404, the first audio signal and the first video signal are converted into a first converted audio signal and a first converted video signal supported by the video telephony software, and then the first converted audio signal and the first converted video signal are transmitted to the computer device.

In one embodiment, the operation S404 of converting the first audio signal and the first video signal into the first converted audio signal and the first converted video signal supported by the video telephony software includes: re-encoding the first video signal into the first converted video signal supported by the video telephony software; and re-sampling and converting the first audio signal into the first converted audio signal supported by the video telephony software.

In operation S405, a second audio signal and a second video signal outputted by the computer device are received, the second audio signal and the second video signal are converted into a second converted audio signal and a second converted video signal supported by the video-audio communication, and then the second converted audio signal and the converted second video signal are transmitted to the conference connection host, so that the conference connection host transmits the second converted audio signal and the second converted video signal to the at least one user device.

In one embodiment, the operation S405 of converting the second audio signal and the second video signal into the second converted audio signal and the second converted video signal supported by the video-audio communication includes: re-sampling and converting the second audio signal into the second converted audio signal supported by the video-audio communication.

In one embodiment, the operation S405 of converting the second audio signal and the second video signal into the second converted audio signal and the second converted video signal supported by the video-audio communication further includes: simulating the second video signal into a simulated display signal of the computer device; and converting the simulated display signal into the second converted video signal supported by the video-audio communication, and then transmitting the second converted video signal to the conference connection host.

In view of the above, with the conversion technology of the present disclosure, there is no need to integrate each communication protocol into the firmware layer of the conference connection host, thereby avoiding the problems of excessive code and memory space.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A connection conference system, comprising:
a conference connection host configured to establish a video-audio communication with at least one user device through a network; and
a conversion device electrically connected to the conference connection host and a computer device, the computer device executing a video telephony software, the conference connection host configured to transmit an audio signal and a first video signal outputted by the at least one user device to the conversion device, and the conversion device configured to convert the first audio signal and the first video signal into a first converted audio signal and a first converted video signal supported by the video telephony software and then transmit the first converted audio signal and the first converted video signal to the computer device.

2. The connection conference system of claim 1, wherein the computer device outputs a second audio signal and a second video signal to the conversion device, and the conversion device converts the second audio signal and the second video signal into a second converted audio signal and a second converted video signal supported by the video-audio communication and then transmits the second converted audio signal and the converted second video signal to the conference connection host, so that the conference connection host transmits the second converted audio signal and the second converted video signal to the at least one user device.

3. The connection conference system of claim 2, wherein the conversion device comprises:
a connection port for electrically connecting the computer device;
a hub electrically connected to the connection port;
a processing unit electrically connected to the hub; and
an interface adapter electrically connected the conference connection host with a first interface and electrically connected the processing unit with a second interface, so that the processing unit converts the first audio signal and the first video signal into the first converted audio signal and the first converted video signal supported by the video telephony software and then transmits the first converted audio signal and the first converted video signal to the computer device through the hub, and the processing unit converts the second audio signal into the second converted audio signal supported by the video-audio communication and then transmits the second converted audio signal to the conference connection host through the interface adapter.

4. The connection conference system of claim 3, wherein the conversion device further comprises:
a display simulation chip electrically connected to the hub, wherein the display simulation chip simulates the second video signal received from the hub into a simulated display signal of the computer device and transmits the simulated display signal to the processing unit, so that the processing unit converts the simulated display signal into the second converted video signal supported by the video-audio communication and then transmits the second converted video signal to the conference connection host through the interface adapter.

5. The connection conference system of claim 4, wherein the processing unit comprises:
a connecting device for electrically connecting the interface adapter with the second interface;
a codec electrically connected to the connecting device and configured to re-encode the first video signal into the first converted video signal supported by the video telephony software; and
a re-sampling circuit electrically connected to the connecting device and configured to re-sample and convert the first audio signal into the first converted audio signal supported by the video telephony software and to re-sample and convert the second audio signal into the second converted audio signal supported by the video-audio communication.

6. The connection conference system of claim 5, wherein the codec converts the simulated display signal into the second converted video signal supported by the video-audio communication.

7. The connection conference system of claim 3, wherein the conversion device further comprises:
a video conversion device electrically connected to the conference connection host and the computer device, and the video conversion device configured to convert the second video signal into the second converted video signal supported by the video-audio communication and then transmit the second converted video signal the conference connection host.

8. A conversion device, comprising:
a connection port for electrically connecting a computer device, and the computer device executing a video telephony software;
a hub electrically connected to the connection port;
a processing unit electrically connected to the hub; and
an interface adapter electrically connected a conference connection host with a first interface and electrically connected the processing unit with a second interface, the conference connection host configured to establish a video-audio communication with at least one user device through a network, the conference connection host configured to transmit an audio signal and a first video signal outputted by the at least one user device to the interface adapter, so that the processing unit converts the first audio signal and the first video signal into a first converted audio signal and a first converted video signal supported by the video telephony software and then transmits the first converted audio signal and the first converted video signal to the computer device through the hub.

9. The conversion device of claim 8, wherein the computer device outputs a second audio signal to the connection port, and the processing unit converts the second audio signal into a second converted audio signal supported by the video-audio communication and then transmits the second converted audio signal to the conference connection host through the interface adapter, so that the conference connection host transmits the second converted audio signal to the at least one user device.

10. The conversion device of claim 8, further comprising:
a display simulation chip electrically connected to the hub, wherein the computer device outputs a second video signal to the connection port, and the display simulation chip simulates the second video signal received from the hub into a simulated display signal of the computer device and transmits the simulated display signal to the processing unit, so that the processing unit converts the simulated display signal into a second converted video signal supported by the video-audio communication and then transmits the second converted video signal to the conference connection host through the interface adapter.

11. The conversion device of claim 10, wherein the processing unit comprises:
a connecting device for electrically connecting the interface adapter with the second interface;
a codec electrically connected to the connecting device and configured to re-encode the first video signal into the first converted video signal supported by the video telephony software; and
a re-sampling circuit electrically connected to the connecting device and configured to re-sample and convert the first audio signal into the first converted audio signal supported by the video telephony software and to re-sample and convert the second audio signal into the second converted audio signal supported by the video-audio communication.

12. The conversion device of claim 11, wherein the codec converts the simulated display signal into the second converted video signal supported by the video-audio communication.

13. The conversion device of claim 11, further comprising:
a video conversion device electrically connected to the conference connection host and the computer device, and the video conversion device configured to convert the second video signal into the second converted video signal supported by the video-audio communication and then transmit the second converted video signal the conference connection host.

14. A connection conference method, comprising steps of:
using a computer device executing a video telephony software;
using a conference connection host to establish a video-audio communication with at least one user device through a network;
receiving an audio signal and a first video signal outputted by the at least one user device from the conference connection host; and
converting the first audio signal and the first video signal into a first converted audio signal and a first converted video signal supported by the video telephony software and then transmit the first converted audio signal and the first converted video signal to the computer device.

15. The connection conference method of claim 14, wherein the step of converting the first audio signal and the first video signal into the first converted audio signal and the first converted video signal supported by the video telephony software comprises:
re-encoding the first video signal into the first converted video signal supported by the video telephony software; and
re-sampling and converting the first audio signal into the first converted audio signal supported by the video telephony software.

16. The connection conference method of claim 14, further comprising:
receiving a second audio signal and a second video signal outputted by the computer device; and
converting the second audio signal and the second video signal into a second converted audio signal and a second converted video signal supported by the video-audio communication and then transmitting the second converted audio signal and the converted second video signal to the conference connection host, so that the conference connection host transmits the second converted audio signal and the second converted video signal to the at least one user device.

17. The connection conference method of claim 16, wherein the step of converting the second audio signal and the second video signal into the second converted audio signal and the second converted video signal supported by the video-audio communication comprises:
re-sampling and converting the second audio signal into the second converted audio signal supported by the video-audio communication.

18. The connection conference method of claim 17, wherein the step of converting the second audio signal and the second video signal into the second converted audio signal and the second converted video signal supported by the video-audio communication further comprises:
simulating the second video signal into a simulated display signal of the computer device; and
converting the simulated display signal into the second converted video signal supported by the video-audio communication, and then transmitting the second converted video signal to the conference connection host.
